(19) United States
(12) Patent Application Publication
(10) Pub. No.: US 2025/0145797 A1
(43) Pub. Date: May 8, 2025

(54) POLYPROPYLENE COMPOSITION WITH IMPROVED OPTICAL CHARACTERISTICS

(71) Applicants: Abu Dhabi Polymers Co. LTD. (Borouge) - Sole Proprietorship L.L.C., Abu Dhabi (AE); BOREALIS AG, Vienna (AT)

(72) Inventors: Subrata Kumar Das, Abu Dhabi (AE); Hans Jozef Francois Van Cauwenberghe, Abu Dhabi (AE); Raghvendra Singh, Abu Dhabi (AE); Mohammed Soboh, Abu Dhabi (AE); Jaycee Lim, Singapore (SG)

(21) Appl. No.: 18/837,015

(22) PCT Filed: Feb. 15, 2023
(86) PCT No.: PCT/EP2023/053684

§ 371 Date: Aug. 8, 2024

(30) Foreign Application Priority Data
Feb. 16, 2022 (EP) 22157113.6

(51) Int. Cl. C08K 5/1575; C08L 23/14

(52) U.S. Cl. CPC C08K 5/1575; C08L 23/142; C08L 2205/02

(57) ABSTRACT

A polypropylene composition (PC), comprising: i) from 95.0 to 99.9 wt.-% of a monophasic propylene-ethylene random copolymer (R-PP) having an MFR₂ in the range from 30 to 60 g/10 min and a C2 content in the range from 5.0 to 8.0 mol-%, and being free from 2,1-regiodefects; and ii) from 0.01 to 0.50 wt.-%, of a first nucleating agent (NU1) having a structure according to formula (I) wherein R is selected from C₂ to C₆ alkyl groups; wherein R¹ to R⁵ are independently selected from the group consisting of hydrogen, alkyl, alkenyl, alkynyl, alkoxy, aryloxy, hydroxyalkyl, cycloalkyl, cycloalkenyl, aryl, substituted aryl, halide, amino and thioether and combinations thereof, and optionally any adjacent R¹ to R⁵ are linked together to form a 5-membered or 6-membered ring; wherein the polypropylene composition (PC) has a haze value in the range from 0.0 to 25.0 %.

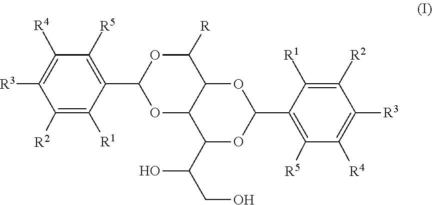

### FIELD OF THE INVENTION

The present invention relates to a polypropylene composition (PC) comprising a specific first nucleating agent (NU1), a process for producing said polypropylene composition and molded articles comprising said polyolefin composition.

### BACKGROUND TO THE INVENTION

Polymers such as polypropylene are widely applied in end-use products, including automotive applications, packaging applications, house ware applications, storage applications, and the like. There is a general need for preparation processes for articles with improved visual appearance formed from clarified polymers with low yellowness.

Transparent thin wall packaging, in particular houseware containers, have particularly high requirements in terms of the mechanical properties, in particular the stiffness and the impact strength, and the optical properties, in particular clarity and improved aesthetics. Although the skilled person knows of many methods to improve each of these properties individually, such an improvement is often accompanied by a decrease in other key properties. For example, whilst it is known that increasing the ethylene comonomer content in polypropylenes will improve the impact strength, the stiffness will typically simultaneously suffer, as will the crystallization temperature of such polypropylenes, affecting the crystallinity and thus clarity.

WO 2017/108771 A1 describes a polypropylene composition employing a specific polypropylene in combination with a sorbitol-based clarifying agent and a zinc fatty acid salt. Although an impressive balance of properties is possible, it is necessary to employ process temperatures in excess of 220° C. (such as 230° C.) in order to dissolve sufficient amounts of the sorbitol-based clarifying agent to achieve the desired optical properties. This is due to the low solubility of sorbitol acetals in polypropylene. Furthermore, the effect of the clarifying agent is affected by many of the other typical additives present in the composition, whilst the clarifying agent may affect the effectiveness of the other additives in turn.

As such, there remains a need to obtain an improved polypropylene composition suitable for thin wall packaging, in particular houseware containers, having an improved balance of mechanical and optical properties, which may be prepared at lower process temperatures than generally employed in the art without unduly affecting the properties of the molded articles thus produced.

### SUMMARY OF THE INVENTION

The present invention is based on the finding that a specific polypropylene, in combination with a specific nucleating agent, in addition to an optional second nucleating agent, an optional fatty acid salt and optional further additives exhibits an improved balance of mechanical and optical properties, with the optical properties in particular being notably improved at low process temperatures, relative to prior art compositions. Furthermore, improved flowability assists with the low-temperature processing of the composition during the molding of articles.

In a first aspect, the present invention is directed to a polypropylene composition (PC), comprising:
i) from 95.0 to 99.9 wt.-%, relative to the total weight of the polypropylene composition (PC), of a monophasic propylene-ethylene random copolymer (R-PP) having a melt flow rate (MFR₂), determined according to ISO 1133 at 230° C. at a load of 2.16 kg, in the range from 30 to 60 g/10 min and an ethylene content, as determined by ¹³C-NMR spectroscopy, in the range from 4.0 to 8.0 mol-%;
ii) from 0.01 to 0.50 wt.-%, relative to the total weight of the polypropylene composition (PC), of a first nucleating agent (NU1) having a structure according to formula (I):

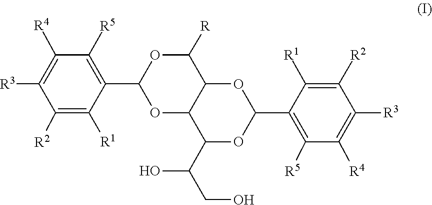

wherein R is selected from C₂ to C₆ alkyl groups;
wherein R¹ to R⁵ are independently selected from the group consisting of hydrogen, alkyl, alkenyl, alkynyl, alkoxy, aryloxy, hydroxyalkyl, cycloalkyl, cycloalkenyl, aryl, substituted aryl, halide, amino and thioether and combinations thereof, and optionally any adjacent R¹ to R⁵ are linked together to form a 5-membered or 6-membered ring;
iii) optionally from 0.1 to 3000 ppm, relative to the total weight of the polypropylene composition (PC), of a second nucleating agent (NU2), being a polymeric nucleating agent;
iv) optionally from 0.010 to 0.150 wt.-%, relative to the total weight of the polypropylene composition (PC), of a fatty acid salt (FAS); and
v) optionally from 0.01 to 5.0 wt.-%, relative to the total weight of the polypropylene composition (PC), of further additives (A),
wherein the individual amounts of the monophasic propylene-ethylene random copolymer (R-PP), the first nucleating agent (NU1), the optional second nucleating agent (NU2), the optional fatty acid salt (FAS), the optional further additives (A) and any further components add up to 100.0 wt.-%,
wherein the polypropylene composition (PC) has a haze value, as determined according to ASTM D 1003-07 on 60×60 mm² plaques with a thickness of 2 mm prepared according to ISO 19069-2 at a temperature of 190° C., in the range from 0.0 to 25.0%.

In a second aspect, the present invention is directed to a polypropylene composition (PC), comprising:
i) from 95.0 to 99.9 wt.-%, relative to the total weight of the polypropylene composition (PC), of a monophasic propylene-ethylene random copolymer (R-PP) having a melt flow rate (MFR₂), determined according to ISO 1133 at 230° C. at a load of 2.16 kg, in the range from 30 to 60 g/10 min and an ethylene content, as determined by ¹³C-NMR spectroscopy, in the range from 4.0 to 8.0 mol-%;
ii) from 0.01 to 0.50 wt.-%, relative to the total weight of the polypropylene composition (PC), of a first nucleating agent (NU1) having a structure according to formula (I):

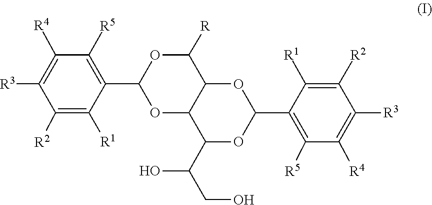

wherein R is selected from C₂ to C₆ alkyl groups;
wherein R¹ to R⁵ are independently selected from the group consisting of hydrogen, alkyl, alkenyl, alkynyl, alkoxy, aryloxy, hydroxyalkyl, cycloalkyl, cycloalkenyl, aryl, substituted aryl, halide, amino and thioether and combinations thereof, and optionally any adjacent R¹ to R⁵ are linked together to form a 5-membered or 6-membered ring;
iii) optionally from 0.1 to 3000 ppm, relative to the total weight of the polypropylene composition (PC), of a second nucleating agent (NU2), being a polymeric nucleating agent;
iv) optionally from 0.010 to 0.150 wt.-%, relative to the total weight of the polypropylene composition (PC), of a fatty acid salt (FAS); and
v) optionally from 0.01 to 5.0 wt.-%, relative to the total weight of the polypropylene composition (PC), of further additives (A),
wherein the individual amounts of the monophasic propylene-ethylene random copolymer (R-PP), the first nucleating agent (NU1), the optional second nucleating agent (NU2), the optional fatty acid salt (FAS), the optional further additives (A) and any further components add up to 100.0 wt.-%,
wherein the polypropylene composition (PC) has a haze value, as determined according to ASTM D 1003-07 on 60×60 mm² plaques with a thickness of 1 mm prepared according to ISO 19069-2 at a temperature of 200° C., in the range from 0.0 to 15.0%.

In a further aspect, the present invention is directed to a molded article comprising at least 90 wt.-%, more preferably at least 95 wt.-%, most preferably at least 97 wt.-% of the inventive polypropylene composition (PC).

In a final aspect, the present invention is divided to a method for producing the molded article of the invention, wherein the temperature in the molding process does not exceed 225° C., more preferably does not exceed 220° C., yet more preferably does not exceed 210° C., most preferably does not exceed 200° C.

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

According to the present invention, the expression “propylene homopolymer” relates to a polypropylene that consists substantially, i.e. of at least 99.5 mol-%, more preferably of at least 99.8 mol-%, like of at least 99.9 mol-%, of propylene units. In another embodiment, only propylene units are detectable, i.e. only propylene has been polymerized.

A propylene random copolymer is a copolymer of propylene monomer units and comonomer units, preferably selected from ethylene and C₄-C₁₂ alpha-olefins, in which the comonomer units are distributed randomly over the polymeric chain. A propylene random copolymer can comprise comonomer units from one or more comonomers different in their amounts of carbon atoms. In the following amounts are given in mol-% unless it is stated otherwise. A propylene random copolymer must contain at least 50 mol-% propylene units.

Typical for propylene homopolymers and propylene random copolymers is the presence of only one glass transition temperature.

Fatty acids are aliphatic monocarboxylic acids with a carbon chain length of 8 to 26, more preferably 10 to 22. The term ‘fully saturated fatty acids’ indicates that the fatty acid does not contain any carbon-carbon double bonds. Specifically preferred fully saturated fatty acids are lauric acid (C₁₂), myristic acid (C₁₄), palmitic acid (C₁₆) and stearic acid (C₁₈).

### DETAILED DESCRIPTION

### The Monophasic Propylene-Ethylene Random Copolymer (R-PP)

One essential component of the polypropylene composition (PC) of both the first and second aspects is the monophasic propylene-ethylene random copolymer (R-PP).

The monophasic propylene-ethylene random copolymer (R-PP) has a melt flow rate (MFR₂), determined according to ISO 1133 at 230° C. at a load of 2.16 kg, in the range from 30 to 60 g/10 min, more preferably in the range from 32 to 55 g/10 min, most preferably in the range from 34 to 50 g/10 min.

The monophasic propylene-ethylene random copolymer (R-PP) has an ethylene content, as determined by ¹³C-NMR spectroscopy, in the range from 4.0 to 8.0 mol-%, more preferably in the range from 4.5 to 7.5 mol-%, most preferably in the range from 5.0 to 7.0 mol-%.

The monophasic propylene-ethylene random copolymer (R-PP) may be polymerized in the presence of either a Ziegler-Natta catalyst system (ZN) or a single-site catalyst system (SSC), preferably in the present of a Ziegler-Natta catalyst system (ZN)

The monophasic propylene-ethylene random copolymer (R-PP) is thus preferably free from 2,1-regiodefects, as determined by quantitative ¹³C-NMR spectroscopy.

The term “2,1 regio defects” as used in the present invention defines the sum of 2,1 erythro regio-defects and 2,1 threo regio-defects

The absence of 2,1-regiodefects in the monophasic propylene-ethylene random copolymer (R-PP) is indicative that the monophasic random propylene-ethylene copolymer (R-PP) has been polymerized in the presence of a Ziegler-Natta catalyst system (ZN).

The monophasic propylene-ethylene random copolymer (R-PP) preferably has a xylene cold soluble content (XCS), as determined according to ISO 16152, in the range from 4.0 to 8.0 wt.-%, more preferably in the range from 4.5 to 7.8 wt.-%, most preferably in the range from 5.0 to 7.5 wt.-%.

In one embodiment, the monophasic propylene-ethylene random copolymer (R-PP) is bimodal.

In this embodiment, it is preferred that the monophasic propylene-ethylene random copolymer (R-PP) comprises:
i) from 35 to 60 wt.-%, relative to the total weight of the monophasic propylene-ethylene random copolymer, of a first propylene-ethylene random copolymer fraction (R-PP1); and
ii) from 40 to 65 wt.-%, relative to the total weight of the monophasic propylene-ethylene random copolymer, of a second propylene-ethylene random copolymer fraction (R-PP2),
wherein the first propylene-ethylene random copolymer fraction (R-PP1) and the second propylene-ethylene random copolymer fraction (R-PP2) combined make up at least 95 wt.-%, more preferably at least 98 wt.-%, most preferably at least 99 wt.-% of the total weight of the monophasic propylene-ethylene random copolymer (R-PP). It is preferred that the monophasic propylene-ethylene random copolymer (R-PP) consists of the first propylene-ethylene random copolymer fraction (R-PP1) and the second propylene-ethylene random copolymer fraction (R-PP2).

In this embodiment, it is further preferred that the monophasic propylene-ethylene random copolymer (R-PP) comprises:
i) from 37 to 55 wt.-%, relative to the total weight of the monophasic propylene-ethylene random copolymer, of a first propylene-ethylene random copolymer fraction (R-PP1); and
ii) from 45 to 63 wt.-%, relative to the total weight of the monophasic propylene-ethylene random copolymer, of a second propylene-ethylene random copolymer fraction (R-PP2).

In this embodiment, it is especially preferred that the monophasic propylene-ethylene random copolymer (R-PP) comprises:
i) from 40 to 50 wt.-%, relative to the total weight of the monophasic propylene-ethylene random copolymer, of a first propylene-ethylene random copolymer fraction (R-PP1); and
ii) from 50 to 60 wt.-%, relative to the total weight of the monophasic propylene-ethylene random copolymer, of a second propylene-ethylene random copolymer fraction (R-PP2).

In this embodiment, the first propylene-ethylene random copolymer fraction (R-PP1) has an ethylene content, as determined by ¹³C-NMR spectroscopy, in the range from 2.0 to 6.0 mol-%, more preferably in the range from 2.5 to 5.8 mol-%, most preferably in the range from 3.0 to 5.5 mol-%.

In this embodiment, the first propylene-ethylene random copolymer fraction (R-PP1) preferably has a melt flow rate (MFR₂), determined according to ISO 1133 at 230° C. at a load of 2.16 kg, in the range from 30 to 60 g/10 min, more preferably in the range from 32 to 55 g/10 min, most preferably in the range from 34 to 50 g/10 min.

In this embodiment, the second propylene-ethylene random copolymer fraction (R-PP2) has an ethylene content in the range from 6.1 to 12.0 mol-%, more preferably in the range from 6.5 to 11.0 mol-%, most preferably in the range from 7.0 to 10.0 mol-%.

In this embodiment, the second propylene-ethylene random copolymer fraction (R-PP2) preferably has a melt flow rate (MFR₂) in the range from 30 to 60 g/10 min, more preferably in the range from 32 to 55 g/10 min, most preferably in the range from 34 to 50 g/10 min.

In this embodiment, it is furthermore preferred that the ratio of the ethylene content of the monophasic propylene-ethylene random copolymer composition (R-PP) to the ethylene content of the first propylene-ethylene random copolymer fraction (R-PP1), both determined by quantitative ¹³C-NMR spectroscopy and expressed in mol-%, ([C2 (R-PP)]/[C2 (R-PP1)]) is in the range from 1.00 to 2.00, more preferably in the range from 1.05 to 1.90, most preferably in the range from 1.10 to 1.80.

### The First Nucleating Agent (NU1)

The other essential feature of the polypropylene composition (PC) of both the first and second aspects is the first nucleating agent (NU1).

The first nucleating agent (NU1) has a structure according to formula (I):

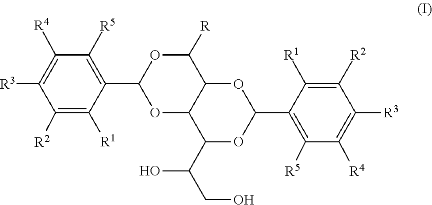

wherein R is selected from C₂ to C₆ alkyl groups;
wherein R¹ to R⁵ are independently selected from the group consisting of hydrogen, alkyl, alkenyl, alkynyl, alkoxy, aryloxy, hydroxyalkyl, cycloalkyl, cycloalkenyl, aryl, substituted aryl, halide, amino and thioether and combinations thereof, and optionally any adjacent R¹ to R⁵ are linked together to form a 5-membered or 6-membered ring.
R is preferably selected from the group consisting of C₂, C₃, C₄, C₅ and C₆ alkyl groups, which may be linear or branched, most preferably linear.

It is particularly preferred that R is selected from ethyl, n-propyl, and n-butyl, most preferably R is n-propyl.
R¹ to R⁵ are preferably independently selected from the group consisting of hydrogen, alkyl, alkoxy and halide, most preferably selected from the group consisting of hydrogen and C₁ to C₆ alkyl.

In one particularly preferred embodiment, R¹, R², R⁴ and R⁵ are hydrogen, whilst R³ is a C₁ to C₆ alkyl, most preferably n-propyl.

Particularly preferred examples of the first nucleating agent (NU1) include the group consisting of 1,2,3-Trideoxy-4,6:5,7-bis-O-(benzylidene) nonitol, 1,2,3-Trideoxy-4,6:5,7-bis-O-(4-methylbenzylidene) nonitol, 1,2,3-Trideoxy-4,6:5,7-bis-O-(3,4-dimethylbenzylidene) nonitol, 1,2,3-Trideoxy-4,6:5,7-bis-O-(3-chlorobenzylidene) nonitol, 1,2,3-Trideoxy-4,6:5,7-bis-O-(4-ethylbenzylidene) nonitol, and 1,2,3-Trideoxy-4,6:5,7-bis-O-(4-propylbenzylidene) nonitol.

It is especially preferred that the first nucleating agent (NU1) is 1,2,3-Trideoxy-4,6:5,7-bis-O-(4-propylbenzylidene) nonitol

### The Second Nucleating Agent (NU2)

One optional component of the polypropylene composition (PC) of both the first and second aspects is the second nucleating agent (NU2).

The second nucleating agent (NU2) is a polymeric nucleating agent.

Preferably, the second nucleating agent (NU2) is a polymeric nucleating agent comprising a monomer (II) of the general formula

H₂C═CH—CHR¹R² (II)

wherein R¹ and R² are either individual alkyl groups with one or more carbon atoms or form an optionally substituted saturated, unsaturated or aromatic ring or a fused ring system containing 4 to 20 carbon atoms, whereby in case R¹ and R² form an aromatic ring, the hydrogen atom of the —CHR¹R² moiety is not present.

Preferred vinyl compounds for the preparation of a polymeric nucleating agent to be used in accordance with the present invention are in particular vinyl cycloalkanes, in particular vinyl cyclohexane (VCH), vinyl cyclopentane, and vinyl-2-methyl cyclohexane, 3-methyl-1-butene, 3-ethyl-1-hexene, 3-methyl-1-pentene, 4-methyl-1-pentene or mixtures thereof. It is particularly preferred that the vinyl polymer is a vinyl cycloalkane polymer, preferably selected from vinyl cyclohexane (VCH), vinyl cyclopentane and vinyl-2-methyl cyclohexane, with vinyl cyclohexane polymer being a particularly preferred embodiment.

It is further preferred that the vinyl polymer of the polymeric nucleating agent is a homopolymer, most preferably a vinyl cyclohexane (VCH) homopolymer.

The second nucleating agent (NU2) may be introduced to the polypropylene composition (PC) either through compounding or through prepolymerisation.

Incorporation via prepolymerisation may be achieved by prepolymerising the catalyst used to produce the monophasic propylene-ethylene random polymer (R-PP) in the presence of the relevant monomer(s), typically known as catalyst modification. Standard prepolymerisation using propylene may be carried out following the catalyst modification step. Suitable catalyst modification technology includes the so-called BNT-technology, which is described in WO 2014/173536 A1 and WO 00/68315 A1.

### The Fatty Acid Salt (FAS)

Another optional component of the polypropylene composition (PC) of both the first and second aspects is the fatty acid salt.

The fatty acid salt is preferably a metal fatty acid salt, more preferably a calcium fatty acid salt.

The fatty acid of the fatty acid salt is preferably a fully saturated fatty acid.

The fatty acid anion is preferably selected from C₁₄ to C₂₂ fatty acids, more preferably C₁₆ to C₂₀ fatty acids, most preferably a C₁₈ fatty acid.

Most preferably, the fatty acid salt is calcium stearate.

### The Further Additives (A)

The polypropylene composition (PC) of both the first and second aspects of the present invention may contain further additives (A) in an amount of from 0.01 to 5.0 wt.-%. The skilled practitioner would be able to select suitable additives that are well known in the art.

The further additives (A) are preferably selected from pigments, antioxidants, UV-stabilisers, anti-scratch agents, mold release agents, acid scavengers, lubricants, anti-static agents, and mixtures thereof.

Such additives are generally commercially available and are described, for example in “Plastic Additives Handbook”, 5th edition, 2001 of Hans Zweifel.

The further additives (A) are preferably free of optical brighteners (OB).

It is understood that the content of further additives (A), given with respect to the total weight of the polypropylene composition (PC), includes any carrier polymers used to introduce the additives to said polypropylene composition (PC), i.e. masterbatch carrier polymers. An example of such a carrier polymer would be a polypropylene homopolymer in the form of powder.

### The Polypropylene Composition (PC)

The polypropylene composition (PC) of both the first and second aspects comprises, more preferably consists of:
i) from 95.0 to 99.9 wt.-%, more preferably from 96.0 to 99.7 wt.-%, most preferably from 97.0 to 99.5 wt.-%, relative to the total weight of the polypropylene composition (PC), of a monophasic propylene-ethylene random copolymer (R-PP);
ii) from 0.01 to 0.50 wt.-%, more preferably from 0.05 to 0.40 wt.-%, most preferably from 0.10 to 0.30 wt.-%, relative to the total weight of the polypropylene composition (PC), of the first nucleating agent (NU1);
iii) optionally from 0.1 to 3000 ppm, more preferably from 0.1 to 1000 ppm, most preferably from 0.1 to 500 ppm, relative to the total weight of the polypropylene composition (PC), of a second nucleating agent, being a polymeric nucleating agent (NU2);
iv) optionally from 0.010 to 0.150 wt.-%, more preferably from 0.020 to 0.120 wt.-%, most preferably from 0.030 to 0.100 wt.-%, relative to the total weight of the polypropylene composition (PC), of the fatty acid salt (FAS); and
v) optionally from 0.01 to 5.0 wt.-%, more preferably from 0.1 to 4.0 wt.-%, most preferably from 0.2 to 3.0 wt.-%, relative to the total weight of the polypropylene composition (PC), of further additives (A).

In the broadest sense, the polypropylene composition (PC) of both the first and second aspects comprises, more preferably consists of:
i) from 95.0 to 99.9 wt.-%, relative to the total weight of the polypropylene composition (PC), of a monophasic propylene-ethylene random copolymer (R-PP);
ii) from 0.01 to 0.50 wt.-%, relative to the total weight of the polypropylene composition (PC), of the first nucleating agent (NU1);
iii) optionally from 0.1 to 3000 ppm, relative to the total weight of the polypropylene composition (PC), of a second nucleating agent, being a polymeric nucleating agent (NU2);
iv) optionally from 0.010 to 0.150 wt.-%, relative to the total weight of the polypropylene composition (PC), of the fatty acid salt (FAS); and
v) optionally from 0.01 to 5.0 wt.-%, relative to the total weight of the polypropylene composition (PC), of further additives (A).

It is preferred that the polypropylene composition (PC) of both the first and second aspects comprises, more preferably consists of:
i) from 96.0 to 99.7 wt.-%, relative to the total weight of the polypropylene composition (PC), of a monophasic propylene-ethylene random copolymer (R-PP);
ii) from 0.05 to 0.40 wt.-%, relative to the total weight of the polypropylene composition (PC), of the first nucleating agent (NU1);
iii) optionally from 0.1 to 1000 ppm, relative to the total weight of the polypropylene composition (PC), of a second nucleating agent, being a polymeric nucleating agent (NU2);
iv) optionally from 0.020 to 0.120 wt.-%, relative to the total weight of the polypropylene composition (PC), of the fatty acid salt (FAS); and
v) optionally from 0.1 to 4.0 wt.-%, relative to the total weight of the polypropylene composition (PC), of further additives (A).

It is further preferred that the polypropylene composition (PC) of both the first and second aspects comprises, more preferably consists of:
i) from 97.0 to 99.5 wt.-%, relative to the total weight of the polypropylene composition (PC), of a monophasic propylene-ethylene random copolymer (R-PP);
ii) from 0.10 to 0.30 wt.-%, relative to the total weight of the polypropylene composition (PC), of the first nucleating agent (NU1);
iii) optionally from 0.1 to 500 ppm, relative to the total weight of the polypropylene composition (PC), of a second nucleating agent, being a polymeric nucleating agent (NU2);
iv) optionally from 0.030 to 0.100 wt.-%, relative to the total weight of the polypropylene composition (PC), of the fatty acid salt (FAS); and
v) optionally from 0.2 to 3.0 wt.-%, relative to the total weight of the polypropylene composition (PC), of further additives (A).

The individual amounts of the monophasic propylene-ethylene random copolymer (R-PP), the first nucleating agent (NU1), the optional second nucleating agent (NU2), the optional fatty acid salt (FAS), the optional further additives (A) and any further components add up to 100.0 wt.-%.

Whilst, in the broadest sense, only the monophasic propylene-ethylene random copolymer (R-PP) and the first nucleating agent (NU1) are essential components, it is preferred that the polypropylene composition (PC) of both the first and second aspects comprises the monophasic propylene-ethylene random copolymer (R-PP), the first nucleating agent (NU1), and the fatty acid salt (FAS) or the polypropylene composition (PC) of both the first and second aspects comprises the monophasic propylene-ethylene random copolymer (R-PP), the first nucleating agent (NU1), and the second nucleating agent (NU2), more preferably the polypropylene composition (PC) comprises the monophasic propylene-ethylene random copolymer (R-PP), the first nucleating agent (NU1), the second nucleating agent (NU2) and the fatty acid salt (FAS), along with any optional further additives (A).

It is preferred that the polypropylene composition (PC) of both the first and second aspects is free from optical brighteners (OB).

Such optical brighteners are typically used to reduce the yellowish appearance of colourless injection-molded articles and typically absorb light in the ultraviolet and violet region of the electromagnetic spectrum and re-emit light in the blue region by fluorescence.

In recent years, some countries have made steps to ban the use of such optical brighteners and as such, it is an additional object of the present invention to achieve acceptable appearance of injection-molded articles without resorting to the use of optical brighteners.

The polypropylene composition (PC) of the first aspect has a haze value, as determined according to ASTM D 1003-07 on 60×60 mm² plaques with a thickness of 2 mm prepared according to ISO 19069-2 at a temperature of 190° C., in the range from 0.0 to 25.0%, more preferably in the range from 0.0 to 23.0%, most preferably in the range from 0.0 to 22.0%.

The polypropylene composition (PC) of the second aspect preferably has a haze value, as determined according to ASTM D 1003-07 on 60×60 mm² plaques with a thickness of 2 mm prepared according to ISO 19069-2 at a temperature of 190° C., in the range from 0.0 to 25.0%, more preferably in the range from 0.0 to 23.0%, most preferably in the range from 0.0 to 22.0%.

The polypropylene composition (PC) of both the first and second aspects preferably has a haze value, as determined according to ASTM D 1003-07 on 60×60 mm² plaques with a thickness of 2 mm prepared according to ISO 19069-2 at a temperature of 200° C., in the range from 0.0 to 25.0%, more preferably in the range from 0.0 to 23.0%, most preferably in the range from 0.0 to 21.0%.

The polypropylene composition (PC) of the first aspect preferably has a haze value, as determined according to ASTM D 1003-07 on 60×60 mm² plaques with a thickness of 1 mm prepared according to ISO 19069-2 at a temperature of 200° C., in the range from 0.0 to 15.0%, more preferably in the range from 0.0 to 12.0%, most preferably in the range from 0.0 to 10.0%.

The polypropylene composition (PC) of the second aspect has a haze value, as determined according to ASTM D 1003-07 on 60×60 mm² plaques with a thickness of 1 mm prepared according to ISO 19069-2 at a temperature of 200° C., in the range from 0.0 to 15.0%, more preferably in the range from 0.0 to 12.0%, most preferably in the range from 0.0 to 10.0%.

The polypropylene composition (PC) of both the first and second aspects preferably has a yellowness index value, as determined according to ASTM E313 on 60×60 mm² plaques with a thickness of 1 mm prepared according to ISO 19069-2 at a temperature of 200° C., in the range from 0.0 to 10.0, more preferably in the range from 0.0 to 9.0, most preferably in the range from 0.0 to 8.0.

The polypropylene composition (PC) of both the first and second aspects preferably has a gloss value at 60°, determined according to ISO 2813 on 60×60 mm² plaques with a thickness of 1 mm prepared according to ISO 19069-2 at a temperature of 200° C., in the range from 90 to 150 GU, more preferably in the range from 100 to 140 GU, most preferably in the range from 110 to 130 GU.

The polypropylene composition (PC) of both the first and second aspects preferably has a melt flow rate (MFR₂), determined according to ISO 1133 at 230° C. at a load of 2.16 kg, in the range from 30 to 60 g/10 min, more preferably in the range from 32 to 55 g/10 min, most preferably in the range from 34 to 50 g/10 min.

The polypropylene composition (PC) of both the first and second aspects preferably has an ethylene content, as determined by ¹³C-NMR spectroscopy, in the range from 4.0 to 8.0 mol-%, more preferably in the range from 4.5 to 7.5 mol-%, most preferably in the range from 5.0 to 7.0 mol-%.

The polypropylene composition (PC) of both the first and second aspects preferably has a xylene cold soluble content (XCS), as determined according to ISO 16152, in the range from 4.0 to 8.0 wt.-%, more preferably in the range from 4.5 to 7.8 wt.-%, most preferably in the range from 5.0 to 7.5 wt.-%.

The polypropylene composition (PC) of both the first and second aspects preferably has a spiral flow at 600 bar in the range from 22.0 to 32.0 cm, more preferably in the range from 22.5 to 31.0 cm, most preferably in the range from 23.0 to 30.0 cm.

The polypropylene composition (PC) of both the first and second aspects preferably has a spiral flow at 1000 bar in the range from 30.0 to 40.0 cm, more preferably in the range from 31.0 to 39.0 cm, most preferably in the range from 31.5 to 38.0 cm.

The polypropylene composition (PC) of both the first and second aspects preferably has a spiral flow at 1400 bar in the range from 37.0 to 50.0 cm, more preferably in the range from 38.0 to 47.0 cm, most preferably in the range from 38.5 to 45.0 cm.

The polypropylene composition (PC) of both the first and second aspects preferably has a shear thinning index, SHI (2.7/210), determined according to ISO 6721, in the range from 8.0 to 18.0, more preferably in the range from 8.5 to 16.0, most preferably in the range from 9.0 to 15.0.

The polypropylene composition (PC) of both the first and second aspects preferably has a shear thinning index, SHI (5/200), determined according to ISO 6721, in the range from 6.0 to 14.0, more preferably in the range from 7.0 to 13.5, most preferably in the range from 8.0 to 13.0.

The polypropylene composition (PC) of both the first and second aspects preferably has a melting temperature Tₘ in the temperature range of 135.0 to 155.0° C., more preferably in the range from 137.0 to 152.0° C., most preferably in the range from 140.0 to 150.0° C.

The polypropylene composition (PC) of both the first and second aspects preferably has a crystallisation temperature T_{c} in the range from 111.0 to 130.0° C., more preferably in the range from 112.0 to 127.0° C., most preferably in the range from 114.0 to 125.0° C.

The polypropylene composition (PC) of both the first and second aspects preferably has a heat of crystallisation H_{c} in the range from 60 to 100 J/g, more preferably in the range from 70 to 95 J/g, most preferably in the range from 75 to 90 J/g.

Tₘ, T_{c}, and H_{c} are determined by differential scanning calorimetry (DSC) according to ISO 11357/part 3/method C2 in a heat/cool/heat cycle with a scan rate of 10° C./min in the temperature range of 0 to +225° C.

The polypropylene composition (PC) of both the first and second aspects preferably has a number average molecular weight (Mn), determined via gel permeation chromatography (GPC), in the range from 15,000 to 30,000 g/mol, more preferably in the range from 17,000 to 27,000 g/mol, most preferably in the range from 18,000 to 24,000 g/mol.

The polypropylene composition (PC) of both the first and second aspects preferably has a weight average molecular weight (Mw), determined via gel permeation chromatography (GPC), in the range from 100,000 to 225,000 g/mol, more preferably in the range from 120,000 to 200,000 g/mol, most preferably in the range from 140,000 to 190,000 g/mol.

The polypropylene composition (PC) of both the first and second aspects preferably has a z-average molecular weight (Mz), determined via gel permeation chromatography (GPC), in the range from 300,000 to 800,000 g/mol, more preferably in the range from 350,000 to 750,000 g/mol, most preferably in the range from 400,000 to 700,000 g/mol.

The polypropylene composition (PC) of both the first and second aspects preferably has a molecular weight distribution (Mw/Mn), determined via gel permeation chromatography (GPC), in the range from 5.0 to 12.0, more preferably in the range from 6.0 to 11.0, most preferably in the range from 7.0 to 10.0.

The polypropylene composition (PC) of both the first and second aspects preferably has a tensile modulus, determined according to ISO 527 on 80×10×4 mm injection-molded specimens prepared according to ISO 19069-2, in the range from 900 to 1500 MPa, more preferably in the range from 920 to 1400 MPa, most preferably in the range from 950 MPa to 1300 MPa.

The polypropylene composition (PC) of both the first and second aspects preferably has a tensile stress at yield, determined according to ISO 527 on 80×10×4 mm injection-molded specimens prepared according to ISO 19069-2, in the range from 20 to 40 MPa, more preferably in the range from 23 to 35 MPa, most preferably in the range from 25 to 32 MPa.

The polypropylene composition (PC) of both the first and second aspects preferably has a flexural modulus, determined according to ISO 178 on 80×10×4 mm injection-molded specimens prepared according to ISO 19069-2, in the range from 900 to 1500 MPa, more preferably in the range from 920 to 1400 MPa, most preferably in the range from 950 to 1300 MPa.

The polypropylene composition (PC) of both the first and second aspects preferably has a Charpy notched impact strength, determined at +23° C. according to ISO 179/1eA on 80×10×4 mm injection-molded specimens prepared according to ISO 19069-2, in the range from 2.0 to 10.0 KJ/m², more preferably in the range from 3.0 to 8.0 KJ/m², most preferably in the range from 4.0 to 6.0 KJ/m².

It is furthermore preferred that the propylene composition (PC) of both the first and second aspects is obtainable via, more preferably obtained via, the process as described below.

### The Molded Article

In a final aspect, the present invention is directed to a molded article comprising at least 90 wt.-%, more preferably at least 95 wt.-%, most preferably at least 97 wt.-% of the inventive polypropylene composition (PC).

Preferably, the molded article has a thickness in the range from 0.4 to 5.0 mm, more preferably in the range from 0.5 to 4.0 mm, most preferably in the range from 0.6 to 3.5 mm.

Preferably, the molded article is prepared via a molding step wherein the temperature does not exceed 225° C., more preferably does not exceed 220° C., yet more preferably does not exceed 210° C., most preferably does not exceed 200° C.

It is preferred that the molded article is an injection-molded article.

The injection-moulded article is preferably applied in packaging applications, such as packaging for adhesives, packaging for cosmetics, packaging for pharmaceuticals and the like, automotive applications, such as side trims, step assists, body panels, spoilers, dashboards, interior trims and the like, medical applications such as such as syringes, catheters, needle hubs, needle protectors, inhalers, filter housings, blood collection systems and the like and house ware applications such as plastic containers, detergent cartons, cup and plate boards for oven or microwave use and the like.

All fallback positions and preferred embodiments of the polypropylene composition (PC), as well as the individual components thereof, apply mutatis mutandis to the article of the present invention.

### The Processes

In a further aspect, the present invention is directed to a process for producing the inventive polypropylene composition (PC), wherein the process involves melt mixing and extruding the monophasic propylene-ethylene random copolymer (R-PP), the first nucleating agent (NU1), the optional nucleating agent (NU2), the optional fatty acid salt (FAS), and the optional further additives (A).

In particular, it is preferred to use a conventional compounding or blending apparatus, e.g. a Banbury mixer, a 2-roll rubber mill, Buss-co-kneader or a twin-screw extruder. More preferably, mixing is accomplished in a co-rotating twin-screw extruder. The polymer materials recovered from the extruder are usually in the form of pellets.

It is particularly preferred that the polypropylene composition (PC) of the present invention is used for the production of injection-molded articles. It is thus preferred that the process further comprises the step of injection molding the polypropylene composition (PC) to form an injection-molded article, more preferably wherein the temperature in the injection molding process does not exceed 225° C., more preferably does not exceed 220° C., yet more preferably does not exceed 210° C., most preferably does not exceed 200° C.

In a final aspect, the present invention is directed to a process for producing the molded article as described in the previous section, wherein the temperature in the molding process does not exceed 220° C., more preferably does not exceed 210° C., most preferably does not exceed 200° C.

The advantageous properties of the inventive polypropylene composition (PC) mean that molded articles can be produced at lower molding temperatures, which is advantageous for economic reasons.

Whilst not wishing to be bound by theory, it is believed that the inventive combination of nucleating agents have improved solubility in the polypropylene composition, meaning that good optical and aesthetic properties can be achieved without using the higher injection molding temperatures that would be required with similar combinations of nucleating agent.

All fallback positions and preferable embodiments of the polypropylene composition (PC), as well as the individual components thereof, apply mutatis mutandis to the processes of the present invention.

### EXAMPLES

### A. Measuring Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the comonomer content and comonomer sequence distribution of the polymers. Quantitative ¹³C {¹H}NMR spectra were recorded in the solution-state using a Bruker Advance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative ¹³C {¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

For polypropylene homopolymers all chemical shifts are internally referenced to the methyl isotactic pentad (mmmm) at 21.85 ppm.

Characteristic signals corresponding to regio defects (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) or comonomer were observed.

The tacticity distribution was quantified through integration of the methyl region between 23.6-19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromoleucles 30 (1997) 6251).

Specifically the influence of regio defects and comonomer on the quantification of the tacticity distribution was corrected for by subtraction of representative regio defect and comonomer integrals from the specific integral regions of the stereo sequences. The isotacticity was determined at the pentad level and reported as the percentage of isotactic pentad (mmmm) sequences with respect to all pentad sequences:

[mmmm]%=100*(mmmm/sum of all pentads)

The presence of 2,1 erythro regio defects was indicated by the presence of the two methyl sites at 17.7 and 17.2 ppm and confirmed by other characteristic sites.

Characteristic signals corresponding to other types of regio defects were not observed (Resconi, L., Cavallo, L., Fait, A., Piemontesi, F., Chem. Rev. 2000, 100, 1253).

The amount of 2,1 erythro regio defects was quantified using the average integral of the two characteristic methyl sites at 17.7 and 17.2 ppm:

$${P}_{21 e} = ( {I}_{e 6} + {I}_{e 8} ) / 2$$

The amount of 1,2 primary inserted propylene was quantified based on the methyl region with correction undertaken for sites included in this region not related to primary insertion and for primary insertion sites excluded from this region:

$${P}_{12} = {I}_{CH 3} + {P}_{12 e}$$

The total amount of propylene was quantified as the sum of primary inserted propylene and all other present regio defects:

$${P}_{total} = {P}_{12} + {P}_{21 e}$$

The mole percent of 2,1 erythro regio defects was quantified with respect to all propylene:

$$[ 21 e ] mol \% = 100 * ( {P}_{21 e} / {P}_{total} )$$

For copolymers characteristic signals corresponding to the incorporation of ethylene were observed (Cheng, H. N., Macromolecules 17 (1984), 1950).

With regio defects also observed (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) correction for the influence of such defects on the comonomer content was required.

The comonomer fraction was quantified using the method of Wang et. al. (Wang, W-J., Zhu, S., Macromolecules 33 (2000), 1157) through integration of multiple signals across the whole spectral region in the ¹³C {¹H}spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S β δ + 0.5 ( S αβ + S α γ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration rgions slightly adjusted to increase applicability to a wider range of comonomer contents.

Calculation of comonomer content of the second propylene-ethylene random copolymer fraction (R-PP2):

$$\frac{C ( PP ) - w ( PP 1 ) \times C ( PP 1 )}{w ( PP 2 )} = C ( PP 2 )$$

wherein
w(PP1) is the weight fraction [in wt.-%] of the first propylene-ethylene random copolymer fraction (R-PP1),
w(PP2) is the weight fraction [in wt.-%] of second propylene-ethylene random copolymer fraction (R-PP2),
C(PP1) is the comonomer content [in mol-%] of the first propylene-ethylene random copolymer fraction (R-PP1),
C(PP) is the comonomer content [in mol-%] of the monophasic propylene-ethylene random copolymer composition (R-PP),
C(PP2) is the calculated comonomer content [in mol-%] of the second propylene-ethylene random copolymer fraction (R-PP2).
MFR₂ (230° C.) is measured according to ISO 1133 (230° C., 2.16 kg load)
Calculation of melt flow rate MFR₂ (230° C.) of the second propylene-ethylene random copolymer fraction (R-PP2):

$$MFR ( PP 2 ) = {10}^{[ \frac{log ( MFR ( PP ) ) - w ( PP 1 ) \times log ( MFR ( PP 1 ) )}{w ( PP )} ]}$$

wherein
w(PP1) is the weight fraction [in wt.-%] of the first propylene-ethylene random copolymer fraction (R-PP1),
w(PP2) is the weight fraction [in wt.-%] of second propylene-ethylene random copolymer fraction (R-PP2),
MFR(PP1) is the melt flow rate MFR₂ (230° C.) [in g/10 min] of the first propylene-ethylene random copolymer fraction (R-PP1),
MFR(PP) is the melt flow rate MFR₂ (230° C.) [in g/10 min] of the monophasic propylene-ethylene random copolymer composition (R-PP),
MFR(PP2) is the calculated melt flow rate MFR₂ (230° C.) [in g/10 min] of the second propylene-ethylene random copolymer fraction (R-PP2).

DSC analysis, melting temperature (Tₘ) and heat of fusion (Hᵣ), crystallization temperature (T_{c}) and heat of crystallization (H_{c}): measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of 0 to +225° C. Crystallization temperature (T_{c}) and heat of crystallization (H_{c}) are determined from the cooling step, while melting temperature (Tₘ) and heat of fusion (H_{f}) are determined from the second heating step.

### Tensile Properties

Tensile Modulus and Stress at yield were measured using injection-molded bar test specimens of 80×10×4 mm³ specimens. Tensile modulus was measured at a speed of 1 mm/min. The testing temperature was 23±2° C. Injection molding was carried out according to ISO 19069-2 using a melt temperature of 230° C. for all materials irrespective of material melt flow rate.

### Flexural Modulus

The Flexural Modulus is determined according to ISO 178 method A (3-point bending test) on 80×10×4 mm³ specimens. Following the standard, a test speed of 2 mm/min and a span length of 16 times the thickness was used. The testing temperature was 23±2° C. Injection molding was carried out according to ISO 19069-2 using a melt temperature of 230° C. for all materials irrespective of material melt flow rate.

### Notched Impact Strength (NIS)

The Charpy notched impact strength (NIS) was measured according to ISO 179 1eA at +23° C., using injection-molded bar test specimens of 80×10×4 mm³ specimens. Injection molding was carried out according to ISO 19069-2 using a melt temperature of 230° C. for all materials irrespective of material melt flow rate.

### The Xylene Solubles (XCS, Wt.-%)

Content of xylene cold solubles (XCS) is determined at 25° C. according ISO 16152; first edition; 2005 Jul. 1. The part which remains insoluble is the xylene cold insoluble (XCI) fraction.

Number average molecular weight (Mn), weight average molecular weight (Mw), Z-average molecular weight (Mz) and molecular weight distribution (MWD) Molecular weight averages (Mz, Mw, Mn), and the molecular weight distribution (MWD), i.e. the Mw/Mn (wherein Mn is the number average molecular weight, Mw is the weight average molecular weight and Mz is the Z-average molecular weight), were determined by Gel Permeation Chromatography (GPC) according to ISO 16014-4:2003 and ASTM D 6474-99. A PolymerChar GPC instrument, equipped with infrared (IR) detector was used with 3×Olexis and 1× Olexis Guard columns from Polymer Laboratories and 1,2,4-trichlorobenzene (TCB, stabilized with 250 mg/L 2,6-Di tert butyl-4-methyl-phenol) as solvent at 160° C. and at a constant flow rate of 1 mL/min. 200 μl. of sample solution were injected per analysis. The column set was calibrated using universal calibration (according to ISO 16014-2:2003) with at least 15 narrow MWD polystyrene (PS) standards in the range from 0.5 kg/mol to 11 500 kg/mol. Mark Houwink constants for PS, PE and PP used are as described per ASTM D 6474-99. All samples were prepared by dissolving 5.0-9.0 mg of polymer in 8 mL (at 160° C.) of stabilized TCB (same as mobile phase) for 2.5 hours for PP or 3 hours for PE at max. 160° C. under continuous gentle shaking in the autosampler of the GPC instrument.

Rheological parameters Shear thinning index SHI_{2.7/210} The characterization of polymer melts by dynamic shear measurements complies with ISO standards 6721-1 and 6721-10. The measurements were performed on an Anton Paar MCR501 rotational rheometer, equipped with a 25 mm parallel plate geometry.

Measurements were undertaken on compression molded plates using nitrogen atmosphere and setting a strain within the linear viscoelastic regime. The oscillatory shear tests were done at 200° C. applying a frequency range between 0.0154 and 500 rad/s and setting a gap of 1.2 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where σ₀, and γ₀ are the stress and strain amplitudes, respectively; w is the angular frequency; δ is the phase shift (loss angle between applied strain and stress response); t is the time.

Dynamic test results are typically expressed by means of several different rheological functions, namely the shear storage modulus, G′, the shear loss modulus, G″, the complex shear modulus, G*, the complex shear viscosity, n*, the dynamic shear viscosity, n′, the out-of-phase component of the complex shear viscosity, n″ and the loss tangent, tan n, which can be expressed as follows:

$$G ' = \frac{{σ}_{0}}{{γ}_{0}} cos δ [ Pa ] \qquad ( 3 )$$

$$G \text{''} = \frac{{σ}_{0}}{{γ}_{0}} sin δ [ Pa ] \qquad ( 4 )$$

$${G}^{*} = G ‘ + iG “ [ Pa ] \qquad ( 5 )$$

$${η}^{*} = {η}^{′} - i η \text{''} [ Pa \cdot s ] \qquad ( 6 )$$

$$η ’ = \frac{{G}^{″}}{ω} [ Pa \cdot s ] \qquad ( 7 )$$

$$η ” = \frac{{G}^{′} ′}{ω} [ Pa \cdot s ] \qquad ( 8 )$$

The determination of so-called Shear Thinning Index, which correlates with MWD and is independent of Mw, is done as described in equation 9.

$${SHI}_{( x / y )} = \frac{Eta * for ( {G}^{*} = x kPa )}{Eta * for ( {G}^{*} = y kPa )} \qquad ( 9 )$$

For example, the SHI_{(2.7/210)} is defined by the value of the complex viscosity, in Pas, determined for a value of G* equal to 2.7 kPa, divided by the value of the complex viscosity, in Pa s, determined for a value of G* equal to 210 kPa.

The values of storage modulus (G′), loss modulus (G″), complex modulus (G*) and complex viscosity (n*) were obtained as a function of frequency (ω).

Thereby, e.g. n* 3_{00rad/s} (eta*_{300rad/s}) is used as abbreviation for the complex viscosity at the frequency of 300 rad/s and n*_{0.05rad/s} (eta*_{0.05rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₃₀₀ is used as abbreviation for the ratio of the loss modulus (G″) and the storage modulus (G′) at 300 rad/s. The elasticity balance tan_{0.05}/tan₃₀₀ is defined as the ratio of the loss tangent tan_{0.05} and the loss tangent tan₃₀₀.

Besides the above mentioned rheological functions one can also determine other rheological parameters such as the so-called elasticity index EI (x). The elasticity index EI (x) is the value of the storage modulus (G′) determined for a value of the loss modulus (G″) of x kPa and can be described by equation 10.

$$EI ( x ) = {G}^{′} for ( {G}^{″} = x kPa ) [ k Pa ] \qquad ( 10 )$$

For example, the EI (5 kPa) is the defined by the value of the storage modulus (G′), determined for a value of G″ equal to 5 kPa.

The viscosity eta₇₄₇ is measured at a very low, constant shear stress of 747 Pa and is inversely proportional to the gravity flow of the polypropylene composition, i.e. the higher eta₇₄₇ the lower the sagging of the polypropylene composition.

The polydispersity index, PI, is defined by equation 11.

$$\begin{matrix}PI = \frac{{10}^{5}}{{G}^{′} ( {ω}_{COP} )} , & {ω}_{COP} = ω for ( G ’ = G ' ’ )\end{matrix} \qquad ( 11 )$$

where ωcop is the cross-over angular frequency, determined as the angular frequency for which the storage modulus, G′, equals the loss modulus, G″.

The values are determined by means of a single point interpolation procedure, as defined by RheoCompass software (Anton Paar rheometer software). In situations for which a given G* value is not experimentally reached, the value is determined by means of an extrapolation, using the same procedure as before. In both cases (interpolation or extrapolation), the option from RheoCompass software (Anton Paar rheometer software) “Interpolate y-values to x-values from parameter” and the “logarithmic interpolation type” were applied.

### REFERENCES

[1] “Rheological characterization of polyethylene fractions”, Heino, E. L., Lehtinen, A., Tanner J., Seppala, J., Neste Oy, Porvoo, Finland, Theor. Appl. Rheol., Proc. Int. Congr. Rheol, 11th (1992), 1, 360-362.
[2] “The influence of molecular structure on some rheological properties of polyethylene”, Heino, E. L., Borealis Polymers Oy, Porvoo, Finland, Annual Transactions of the Nordic Rheology Society, 1995.
[3] “Definition of terms relating to the non-ultimate mechanical properties of polymers”, Pure & Appl. Chem., Vol. 70, No. 3, pp. 701-754, 1998.

### Zero Shear Viscosity

The determination of the so-called Zero Shear Viscosity is determined in the RheoCompass software (Anton Paar rheometer software) by the use of the Carreau-Yasuda model. The Carreau-Yasuda equation describes the viscosity curve of a material with Newtonian regions at low shear rates and a shear thinning region (power law region) at medium shear rates.

$$y = ( {y}_{0} - {y}_{inf} ) \cdot {( 1 + {( λ \cdot x )}^{a} )}^{\frac{n - 1}{n}} + {y}_{inf} \qquad ( 12 )$$

where
x angular frequency in rad/s
y complex viscosity in Pa's
y₀ complex viscosity for angular frequency→0 (zero shear viscosity) in Pas
Y_{inf} complex viscosity at angular frequency→∞(infinite viscosity) in Pa's
a Carreau constant
n Power index
λ relaxation time in s

### Spiral Flow Properties

Spiral Test is carried out using an Engel ES330/65 cc90 injection moulding apparatus with a spiral mould and pressure of 600, 1000 or 1400 bar
screw diameter: 35 mm
max. piston displacement: 150 cm³
spec. injection pressure: 600, 1000, or 1400 bar
tool form: oval form; provided by Axxicon; thickness 1 mm, breadth: 5 mm
temperature in pre-chamber and die: 230° C.
temperature in zone 2/zone 3/zone 4/zone 5:230° C./230° C./225° C./190° C.
injection cycle: injection time including holding: 10 s
cooling time: 15 s
injection pressure: Follows from the predetermined length of the testing material.
dwell pressure=injection pressure
screw speed: 30 rpm
system pressure: 10 bar
metering path: should be chosen so that the screw stops 20 mm before its final position at the
end of the dwell pressure.
tool temperature: 40° C.

The spiral flow length can be determined immediately after the injection operation.

Haze was determined according to ASTM D1003-07 on plaques with dimensions 60×60×1 mm³ or 60×60×2 mm³ from injection-molded plaques prepared at either 190 or 200° C. according to ISO19069-2.

Gloss was determined according to ISO 2813 on plaques with dimensions 60×60×1 mm³ or 60×60×2 mm³ machined from injection-molded plaques prepared at either 190 or 200° C. according to ISO19069-2.

### Yellowness Index

The yellowness index was measured according to ASTM E313. The plaques used had dimensions 60×60×1 mm³ and were prepared at 200° C. according to ISO19069-2.

### 2. Examples

### 2.1. Synthesis of the monophasic propylene-ethylene random copolymers (R-PP)

The catalyst used in the polymerization of the comparative (R-PP′) and inventive (R-PP) monophasic propylene-ethylene random copolymers was a Ziegler-Natta catalyst from Borealis having Ti-content of 1.9 wt.-% (as described in EP 591 224 A1).

The monophasic propylene-ethylene random copolymers were polymerized according to the conditions given in Table 1 (note: The MFR₂ and C2 content given after reactor R² are the properties of the GPR fraction (i.e. R-PP2) and were calculated from the values measured after the loop reactor (i.e. R-PP1) and in the final pellets (i.e. R-PP), using appropriate mixing rules, as given in the determination methods) for both R-PP′ and R-PP respectively.

TABLE 1
Polymerisation conditions for the monophasic
propylene-ethylene random copolymers

| | |
|---|---|
| R-PP′ | R-PP |

Prepolymerization (R0)

| | | | |
|---|---|---|---|
| Temperature | [° C.] | 30 | 30 |
| Pressure | [kPa] | 5300 | 5300 |
| Donor feed | [g/t(C3)] | 50 | 31 |
| TEAL feed | [g/t(C3)] | 130 | 130 |
| H2 feed | [g/h] | 40 | 33 |

Loop reactor (R1)

| | | | |
|---|---|---|---|
| Temperature | [° C.] | 70 | 70 |
| Pressure | [kPa] | 5300 | 5300 |
| H2/C3 ratio | [mol/kmol] | 15.6 | 18.1 |
| C2/C3 ratio | [mol/kmol] | 1.45 | 1.46 |
| split | [wt.-%] | 44 | 45 |
| MFR₂ | [g/10 min] | 30 | 41 |
| XCS | [wt.-%] | 5.7 | 6.0 |
| C2 content | [mol-%] | 4.2 | 4.4 |

GPR (R2)

| | | | |
|---|---|---|---|
| Temperature | [° C.] | 82 | 82 |
| Pressure | [kPa] | 2172 | 2200 |
| H2/C3 ratio | [mol/kmol] | 200 | 270 |
| C2/C3 ratio | [mol/kmol] | 36 | 39 |
| split | [wt.-%] | 56 | 55 |
| MFR₂ | [g/10 min] | 30 | 41 |
| C2 content | [mol-%] | 6.7 | 8.0 |

R-PP

| | | | |
|---|---|---|---|
| MFR₂ | [g/10 min] | 30 | 42 |
| C2 content | [mol-%] | 5.6 | 6.4 |
| XCS | [wt.-%] | 5.8 | 6.2 |
| 2,1 regiodefects | [mol-%] | 0.0 | 0.0 |
| C2(R-PP)/C2(R-PP1) | [—] | 1.33 | 1.45 |

### 2.2. Compounding of Examples

The inventive (IE) and comparative (CE) examples were prepared based on the recipes indicated in Table 2 by compounding in a ‘compounding’ co-rotating twin-screw extruder with an extrusion temperature in the range from 180 to 235° C.

TABLE 2
Recipes for comparative and inventive polypropylene compositions

| | | CE1 | IE |
|---|---|---|---|
| R-PP′ | [wt.-%] | 97.6150 | — |
| R-PP | [wt.-%] | — | 97.6250 |
| Irganox 1010 | [wt.-%] | 0.0315 | 0.0350 |
| Irgafos 168 | [wt.-%] | 0.0630 | 0.0600 |
| ZnSt | [wt.-%] | 0.0500 | — |
| CaSt | [wt.-%] | — | 0.0400 |
| GMS95 | [wt.-%] | 0.0400 | 0.0400 |
| Sorbitol | [wt.-%] | 0.2000 | — |
| Nonitol | [wt.-%] | — | 0.2000 |
| OB | [wt.-%] | 0.0005 | — |
| BNT PP | [wt.-%] | 2.0000 | 2.0000 |

Irganox 1010 Pentaerythritol tetrakis(3-(3,5-di-tert-butyl-4-hydroxyphenyl)propionate) (CAS-no. 6683-19-8), an antioxidant, commercially available from BASF SE (Germany).
Irgafos 168 Tris(2,4-di-tert-butylphenyl)phosphite (CAS-no. 31570-04-4), an antioxidant, commercially available from BASF SE (Germany).
ZnSt Zinc stearate (CAS-no. 557-05-1), commercially available from Faci SpA (IT).
CaSt Calcium stearate (CAS-no. 1592-23-0), commercially available from Faci SpA (IT).
GMS-95 Glyceryl monostearate (CAS-no. 123-94-4), an antistatic agent, commercially available from Oleon NV (BE).
Sorbitol 1,3:2,4-Bis(3,4-dimethylobenzylideno)sorbitol (CAS-no. 97593-29-8), commercially available under the trade name Millad 3988 from Milliken & Co (US).
Nonitol 1,2,3-Trideoxy-4,6:5,7-bis-O-(4-propylbenzylidene)nonitol (CAS-no. 882073-43-0), commercially available under the trade name Millad NX8000 ECO from Milliken & Co (US).
Tinopal ® OB 2,5-thiophenediylbis(5-tert-butyl-1,3-benzoxazole) (CAS-no. 7128-64-5), an optical brightener, commercially available from BASH SE (Germany).
BNT PP A BNT-nucleated propylene homopolymer, having a BNT content of 12 ppm.

TABLE 3
Properties of the comparative and inventive
polypropylene compositions

| | | CE1 | IE |
|---|---|---|---|
| MFR₂ | [g/10 min] | 30 | 42 |
| C2 content | [mol-%] | 5.6 | 6.4 |
| XCS | [wt.-%] | 5.8 | 6.2 |
| Spiral flow specimen length | [cm] | 21.9 | 23.3 |
| @600 bar | | | |
| Spiral flow specimen length | [cm] | 29.9 | 32.0 |
| @1000 bar | | | |
| Spiral flow specimen length | [cm] | 36.8 | 39.0 |
| @1400 bar | | | |
| Zero shear viscosity | [Pa · s] | 919 | 631 |
| SHI_{(2.7/210)} | [—] | 18.6 | 12.5 |
| SHI_{(5/200)} | [—] | 15.2 | 10.3 |
| Tm | [° C.] | 146.9 | 148.1 |
| Tc | [° C.] | 121.1 | 122.2 |
| Hc | [J/g] | 83 | 85 |
| Mw | [g/mol] | 180,050 | 168,700 |
| Mn | [g/mol] | 22,300 | 21,200 |
| Mw/Mn | [—] | 8.07 | 7.96 |
| Mz | [g/mol] | 545,000 | 504,400 |
| Tensile Modulus | [MPa] | 1150 | 1000 |
| Tensile Stress at yield | [MPa] | 29 | 28 |
| Flexural Modulus | [MPa] | 1160 | 1000 |
| Charpy NIS | [kJ/m²] | 4.1 | 4.2 |
| Haze (2 mm, 190° C.) | [%] | 33.8 | 21.3 |
| Haze (2 mm, 200° C.) | [%] | 32.7 | 20.1 |
| Haze (1 mm, 200° C.) | [%] | 14.0 | 9.1 |
| Yellowness index (1 mm) | [—] | 6.5 | 7.2 |
| Gloss at 60° | [GU] | 104 | 116 |

As can be seen from the rheological measurements (Spiral flow, zero shear viscosity, SHI (2.7/210), and SHI (5/200)), the inventive composition has superior flowability.

More critically, the haze values are much lower for the inventive composition, whilst the yellowness index and gloss are largely unchanged, despite the fact that the inventive example does not contain an optical brightener. Furthermore, visual inspection of injection-molded articles prepared from the comparative and inventive compositions indicates that despite the yellowness index measured above, the inventive injection-molded articles appear less yellow to the naked eye than the comparative injection-molded articles.

The DSC measurements (Tₘ, T_{c}, H_{c}) indicate a higher level of crystallinity for the inventive composition.

Importantly, the inventive composition has the specific advantage that thin-walled articles with optical properties may be produced at lower processing temperatures than previously possible with known compositions, such as the comparative composition. This is advantageous for both economic reasons and for minimising potential polymer degradation at higher temperatures.

1. A polypropylene composition (PC), comprising:
i) from 95.0 to 99.9 wt. %, relative to the total weight of the polypropylene composition (PC), of a monophasic propylene-ethylene random copolymer (R-PP) having a melt flow rate (MFR₂), determined according to ISO 1133 at 230° C. at a load of 2.16 kg, in the range from 30 to 60 g/10 min and an ethylene content, as determined by ¹³C-NMR spectroscopy, in the range from 4.0 to 8.0 mol %;
i) from 0.01 to 0.50 wt. %, relative to the total weight of the polypropylene composition (PC), of a first nucleating agent (NU1) having a structure according to formula (I): 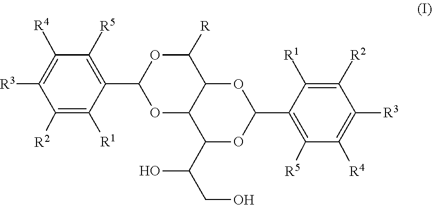
wherein R is selected from C₂ to C₆ alkyl groups;
wherein R¹ to R⁵ are independently selected from the group consisting of hydrogen, alkyl, alkenyl, alkynyl, alkoxy, aryloxy, hydroxyalkyl, cycloalkyl, cycloalkenyl, aryl, substituted aryl, halide, amino and thioether and combinations thereof, and optionally any adjacent R¹ to R⁵ are linked together to form a 5-membered or 6-membered ring;
iii) optionally from 0.1 to 3000 ppm, relative to the total weight of the polypropylene composition (PC), of a second nucleating agent (NU2), being a polymeric nucleating agent;
iv) optionally from 0.010 to 0.150 wt. %, relative to the total weight of the polypropylene composition (PC), of a fatty acid salt (FAS); and
v) optionally from 0.01 to 5.0 wt. %, relative to the total weight of the polypropylene composition (PC), of further additives (A),
wherein the individual amounts of the monophasic propylene-ethylene random copolymer (R-PP), the first nucleating agent (NU1), the optional second nucleating agent (NU2), the optional fatty acid salt (FAS), the optional further additives (A) and any further components add up to 100.0 wt. %,
wherein the polypropylene composition (PC) has a haze value, as determined according to ASTM D 1003-07 on 60×60 mm² plaques with a thickness of 2 mm prepared according to ISO 19069-2 at a temperature of 190° C., in the range from 0.0 to 25.0%.

2. A polypropylene composition (PC), comprising:
i) from 95.0 to 99.9 wt. %, relative to the total weight of the polypropylene composition (PC), of a monophasic propylene-ethylene random copolymer (R-PP) having a melt flow rate (MFR₂), determined according to ISO 1133 at 230° C. at a load of 2.16 kg, in the range from 30 to 60 g/10 min and an ethylene content, as determined by ¹³C-NMR spectroscopy, in the range from 4.0 to 8.0 mol %;
ii) from 0.01 to 0.50 wt. %, relative to the total weight of the polypropylene composition (PC), of a first nucleating agent (NU1) having a structure according to formula (I): 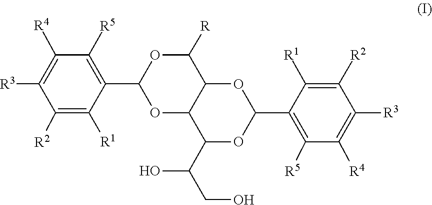
wherein R is selected from C₂ to C₆ alkyl groups;
wherein R¹ to R⁵ are independently selected from the group consisting of hydrogen, alkyl, alkenyl, alkynyl, alkoxy, aryloxy, hydroxyalkyl, cycloalkyl, cycloalkenyl, aryl, substituted aryl, halide, amino and thioether and combinations thereof, and optionally any adjacent R¹ to R⁵ are linked together to form a 5-membered or 6-membered ring;
iii) optionally from 0.1 to 3000 ppm, relative to the total weight of the polypropylene composition (PC), of a second nucleating agent (NU2), being a polymeric nucleating agent;
iv) optionally from 0.010 to 0.150 wt. %, relative to the total weight of the polypropylene composition (PC), of a fatty acid salt (FAS); and
v) optionally from 0.01 to 5.0 wt. %, relative to the total weight of the polypropylene composition (PC), of further additives (A),
wherein the individual amounts of the monophasic propylene-ethylene random copolymer (R-PP), the first nucleating agent (NU1), the optional second nucleating agent (NU2), the optional fatty acid salt (FAS), the optional further additives (A) and any further components add up to 100.0 wt. %,
wherein the polypropylene composition (PC) has a haze value, as determined according to ASTM D 1003-07 on 60×60 mm² plaques with a thickness of 1 mm prepared according to ISO 19069-2 at a temperature of 200° C., in the range from 0.0 to 15.0%.

3. The polypropylene composition (PC) according to claim 1, wherein the first nucleating agent (NU1) has a structure according to formula (I) wherein R is n-propyl.

4. The polypropylene composition (PC) according to claim 3, wherein the first nucleating agent (NU1) is selected from the group consisting of 1,2,3-Trideoxy-4,6:5,7-bis-O-(benzylidene) nonitol, 1,2,3-Trideoxy-4,6:5,7-bis-O-(4-methylbenzylidene) nonitol, 1,2,3-Trideoxy-4,6:5,7-bis-O-(3,4-dimethylbenzylidene) nonitol, 1,2,3-Trideoxy-4,6:5,7-bis-O-(3-chlorobenzylidene) nonitol, 1,2,3-Trideoxy-4,6:5,7-bis-O-(4-ethylbenzylidene) nonitol, and 1,2,3-Trideoxy-4,6:5,7-bis-O-(4-propylbenzylidene) nonitol.

5. The polypropylene composition (PC) according to claim 1, wherein the monophasic propylene-ethylene random copolymer (R-PP) has a xylene cold soluble content (XCS), as determined according to ISO 16152, in the range from 4.0 to 8.0 wt. %.

6. The polypropylene composition (PC) according to claim 1, wherein the monophasic propylene-ethylene random copolymer (R-PP) comprises:
i) from 35 to 60 wt. %, relative to the total weight of the monophasic propylene-ethylene random copolymer, of a first propylene-ethylene random copolymer fraction (R-PP1), having an ethylene content as determined by ¹³C-NMR spectroscopy, in the range from 2.0 to 6.0 mol %; and
ii) from 40 to 65 wt. %, relative to the total weight of the monophasic propylene-ethylene random copolymer, of a second propylene-ethylene random copolymer fraction (R-PP2), having an ethylene content in the range from 6.1 to 12.0 mol %;
wherein the first propylene-ethylene random copolymer fraction (R-PP1) and the second propylene-ethylene random copolymer fraction (R-PP2) combined make up at least 95 wt. % of the total weight of the monophasic propylene-ethylene random copolymer (R-PP).

7. The polypropylene composition (PC) according to claim 1, wherein the fatty acid salt is a calcium fatty acid salt.

8. The polypropylene composition (PC) according to claim 1, wherein the second nucleating agent (NU2) is a polymeric nucleating agent comprising a monomer (II) of the general formula:
H₂C═CH—CHR¹R² (II)
wherein R¹ and R² are either individual alkyl groups with one or more carbon atoms or form an optionally substituted saturated, unsaturated or aromatic ring or a fused ring system containing 4 to 20 carbon atoms, whereby in case R¹ and R² form an aromatic ring, the hydrogen atom of the —CHR¹R² moiety is not present.

9. The polypropylene composition (PC) according to claim 1, being free from optical brighteners (OB).

10. The polypropylene composition (PC) according to claim 1, consisting of:
i) from 95.0 to 99.9 wt. %, relative to the total weight of the polypropylene composition (PC), of a monophasic propylene-ethylene random copolymer (R-PP);
ii) from 0.01 to 0.50 wt. %, relative to the total weight of the polypropylene composition (PC), of the first nucleating agent (NU1);
iii) optionally from 0.1 to 3000 ppm, relative to the total weight of the polypropylene composition (PC), of a second nucleating agent, being a polymeric nucleating agent (NU2);
iv) optionally from 0.010 to 0.150 wt. %, relative to the total weight of the polypropylene composition (PC), of the fatty acid salt (FAS); and
v) optionally from 0.01 to 5.0 wt. %, relative to the total weight of the polypropylene composition (PC), of further additives (A).

11. The polypropylene composition (PC) according to claim 1, having at least one of the following properties:
a) a melting temperature Tₘ in the temperature range of 135.0 to 155.0° C.;
b) a crystallisation temperature T_{c} in the range from 110.0 to 130.0° C.;
c) a heat of crystallisation H_{c} in the range from 60 to 100 J/g,
wherein Tₘ, T_{c}, and H_{c} are determined by differential scanning calorimetry (DSC) according to ISO 11357/part 3/method C2 in a heat/cool/heat cycle with a scan rate of 10° C./min in the temperature range of 0 to +225° C.

12. The polypropylene composition (PC) according to claim 1, having at least one of the following properties:
a) a tensile modulus, determined according to ISO 527 on 80×10×4 mm injection-molded specimens prepared according to ISO 19069-2, in the range from 900 to 1500 MPa;
b) a tensile stress at yield, determined according to ISO 527 on 80×10×4 mm injection-molded specimens prepared according to ISO 19069-2, in the range from 20 to 40 MPa;
c) a flexural modulus, determined according to ISO 178 on 80×10×4 mm injection-molded specimens prepared according to ISO 19069-2, in the range from 900 to 1500 MPa; and
d) a Charpy notched impact strength, determined at +23° C. according to ISO 179/1eA on 80×10×4 mm injection-molded specimens prepared according to ISO 19069-2, in the range from 2.0 to 10.0 KJ/m².

13. A molded article comprising at least 90 wt. % of the polypropylene composition (PC) according to claim 1.

14. The molded article according to claim 13, wherein the article has a thickness in the range from 0.4 to 5.0 mm.

15. A process for producing the molded article according to claim 13, wherein the temperature in the molding process does not exceed 225° C.

16. The molded article according to claim 13, wherein the molded article is obtained via, the process according to claim 15.

17. The polypropylene composition (PC) according to claim 6, wherein the ratio of the ethylene content of the monophasic propylene-ethylene random copolymer composition (R-PP) to the ethylene content of the first propylene-ethylene random copolymer fraction (R-PP1), both determined by quantitative ¹³C-NMR spectroscopy and expressed in mol %, ([C2 (R PP)]/[C2 (R-PP1)]) is in the range from 1.00 to 2.00.
